(19) United States
(12) Patent Application Publication
(10) Pub. No.: US 2018/0137634 A1
(43) Pub. Date: May 17, 2018

(54) DYNAMIC IMAGE PROCESSING SYSTEM

(71) Applicant: Konica Minolta, Inc., Tokyo (JP)

(72) Inventor: Koichi Fujiwara, Tokyo (JP)

(21) Appl. No.: 15/801,911

(22) Filed: Nov. 2, 2017

(30) Foreign Application Priority Data
Nov. 15, 2016 (JP) 2016-222052

(51) Int. Cl. G06T 7/33; G06T 7/00

(52) U.S. Cl. CPC G06T 7/337; G06T 7/0016; G06T 2207/10016; G06T 2207/20021; G06T 2207/30061; G06T 2200/28; G06T 2207/30048

(57) ABSTRACT

A dynamic image processing system, including: a storage in which a first dynamic image and information on an image feature that is input or specified by a user and based on the first dynamic image are stored so as to be associated with each other, the first dynamic image being obtained by photographing a dynamic state of a subject which has periodicity; and a hardware processor which determines a frame image group that is to be displayed and compared with the first dynamic image from among frame image groups for a plurality of respective periods in a second dynamic image based on the information on the image feature that is stored so as to be associated with the first dynamic image, the second dynamic image being obtained by photographing the dynamic state for the periods after photographing of the first dynamic image.

### BACKGROUND

### 1. Technological Field

The present invention relates to a dynamic image processing system.

### 2. Description of the Related Art

In recent years, use of digital techniques has enabled users to relatively easily obtain images capturing movement of patients (referred to as dynamic images) by radiation imaging. For example, it is possible to obtain a dynamic image capturing a site which is a target of examination and diagnosis by imaging using a semiconductor image sensor such as an FPD (Flat Panel Detector).

The disease progress and the degree of recovery are grasped by comparing a medical image obtained by photographing a patient with a past medical image of the patient. Attempts to compare a dynamic image with a dynamic image which was obtained in the past have also been made similarly.

For example, Patent document 1 (Japanese Patent Application Laid Open Publication No. 2005-151099) describes inputting respiration moving images at two time points which are temporally distant from each other, determining a past image and a current image (reference image and target image) which have matching respiration phase states, and performing difference processing between the images. Patent document 2 (Japanese Patent Application Laid Open Publication No. 2013-81579) describes aligning phases of start frames with each other when a past dynamic image and a target dynamic image are displayed alongside.

Though the Patent documents 1 and 2 describe aligning the phases of the dynamic images to be compared, when the respiration or pulmonary blood flow signal exists in a plurality of periods in the photographed dynamic image, the user is not certain which period to select to compare the frame image groups and perform diagnosis.

### SUMMARY

An object of the present invention is to enable automatic determination of a frame image group which is appropriate to be compared with a past dynamic image from a dynamic image.

To achieve at least one of the abovementioned objects, according to an aspect of the present invention, a dynamic image processing system reflecting one aspect of the present invention comprises: a storage in which a first dynamic image and information on an image feature that is input or specified by a user and based on the first dynamic image are stored so as to be associated with each other, the first dynamic image being obtained by photographing a dynamic state of a subject which has periodicity; and a hardware processor which determines a frame image group that is to be displayed and compared with the first dynamic image from among frame image groups for a plurality of respective periods in a second dynamic image based on the information on the image feature that is stored so as to be associated with the first dynamic image, the second dynamic image being obtained by photographing the dynamic state for the periods after photographing of the first dynamic image.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a view showing the entire configuration of a dynamic image processing system in an embodiment of the present invention;

FIG. 2 is a flowchart showing imaging control processing executed by a control section of an imaging console in FIG. 1;

FIG. 3 is a flowchart showing dynamic image display processing executed by a control section of a diagnostic console in FIG. 1;

FIG. 4 is a view for explaining a method of dividing a dynamic image into a plurality of frame image groups; and

FIG. 5 is a flowchart showing analysis result image display processing executed by the control section of the diagnostic console in FIG. 1.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

### [Configuration of Dynamic Image Processing System 100]

First, the configuration in a first embodiment will be described.

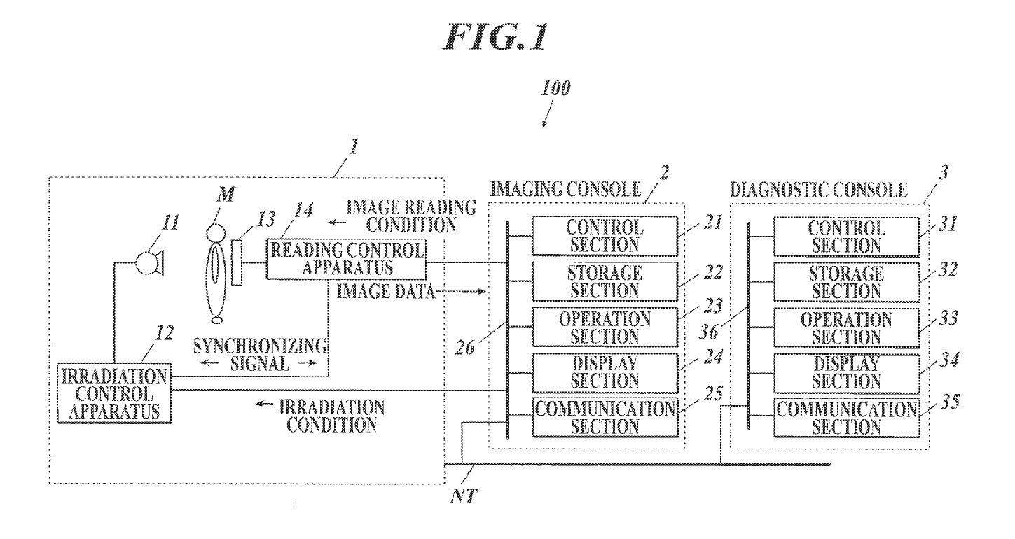

FIG. 1 shows the entire configuration of a dynamic image processing system 100 in the embodiment.

As shown in FIG. 1, the dynamic image processing system 100 is configured by connecting an imaging apparatus 1 to an imaging console 2 via a communication cable and such like, and connecting the imaging console 2 to a diagnostic console 3 via a communication network NT such as a LAN (Local Area Network). The apparatuses forming the dynamic image processing system 100 are compliant with the DICOM (Digital Image and Communications in Medicine) standard, and the apparatuses are communicated with each other according to the DICOM.

### [Configuration of Imaging Apparatus 1]

The imaging apparatus 1 performs imaging of a dynamic state in a subject which has periodicity, such as the state change of inflation and deflation of a lung according to the respiration movement and the heart beat, for example. The dynamic imaging means obtaining a plurality of images by repeatedly emitting a pulsed radiation such as X-ray to a subject at a predetermined time interval (pulse irradiation) or continuously emitting the radiation (continuous irradiation) at a low dose rate without interruption. A series of images obtained by the dynamic imaging is referred to as a dynamic image. Each of the plurality of images forming the dynamic image is referred to as a frame image. Hereinafter, the embodiment will be described by taking, as an example, a case where the dynamic imaging is performed by the pulse irradiation. Though the following embodiment will be described by taking, as an example, a case where a subject M is a chest of a patient being tested, the present invention is not limited to this.

A radiation source 11 is located at a position facing a radiation detection section 13 through a subject M, and emits radiation (X ray) to the subject M in accordance with control of an irradiation control apparatus 12.

The irradiation control apparatus 12 is connected to the imaging console 2, and performs radiation imaging by controlling the radiation source 11 on the basis of an irradiation condition which was input from the imaging console 2. The irradiation condition input from the imaging console 2 is a pulse rate, a pulse width, a pulse interval, the number of imaging frames per imaging, a value of X-ray tube current, a value of X-ray tube voltage and a type of applied filter, for example. The pulse rate is the number of irradiation per second and consistent with an after-mentioned frame rate. The pulse width is an irradiation time required for one irradiation. The pulse interval is a time from start of one irradiation to start of next irradiation, and consistent with an after-mentioned frame interval.

The radiation detection section 13 is configured by including a semiconductor image sensor such as an FPD. The FPD has a glass substrate, for example, and a plurality of detection elements (pixels) is arranged in matrix at a predetermined position on the substrate to detect, according to the intensity, radiation which was emitted from the radiation source 11 and has transmitted through at least the subject M. and convert the detected radiation into electric signals to be accumulated. Each pixel is formed of a switching section such as a TFT (Thin Film Transistor), for example. The FPD may be an indirect conversion type which converts X ray into an electrical signal by photoelectric conversion element via a scintillator, or may be a direct conversion type which directly converts X ray into an electrical signal. In the embodiment, a pixel value (signal value) of image data generated in the radiation detection section 13 is a density value and higher as the transmission amount of the radiation is larger.

The radiation detection section 13 is provided to face the radiation source 11 via the subject M.

The reading control apparatus 14 is connected to the imaging console 2. The reading control apparatus 14 controls the switching sections of respective pixels in the radiation detection section 13 on the basis of an image reading condition input from the imaging console 2, switches the reading of electric signals accumulated in the pixels, and reads out the electric signals accumulated in the radiation detection section 13 to obtain image data. The image data is a frame image. The reading control apparatus 14 outputs the obtained frame image to the imaging console 2. The image reading condition is, for example, a frame rate, frame interval, a pixel size and an image size (matrix size). The frame rate is the number of frame images obtained per second and consistent with the pulse rate. The frame interval is a time from start of obtaining one frame image to start of obtaining the next frame image, and consistent with the pulse interval.

Here, the irradiation control apparatus 12 and the reading control apparatus 14 are connected to each other, and transmit synchronizing signals to each other to synchronize the irradiation operation with the image reading operation.

### [Configuration of Imaging Console 2]

The imaging console 2 outputs the irradiation condition and the image reading condition to the imaging apparatus 1, controls the radiation imaging and reading operation of radiation images by the imaging apparatus 1, and displays the dynamic image obtained by the imaging apparatus 1 so that an operator who performs the imaging such as an imaging operator confirms the positioning and whether the image is appropriate for diagnosis.

As shown in FIG. 1, the imaging console 2 is configured by including a control section 21, a storage section 22, an operation section 23, a display section 24 and a communication section 25, which are connected to each other via a bus 26.

The control section 21 is configured by including a CPU (Central Processing Unit), a RAM (Random Access Memory) and such like. According to the operation of the operation section 23, the CPU of the control section 21 reads out system programs and various processing programs stored in the storage section 22 to load the programs into the RAM, executes various types of processing including after-mentioned imaging control processing in accordance with the loaded programs, and integrally controls the operations of the sections in the imaging console 2 and the irradiation operation and reading operation of the imaging apparatus 1.

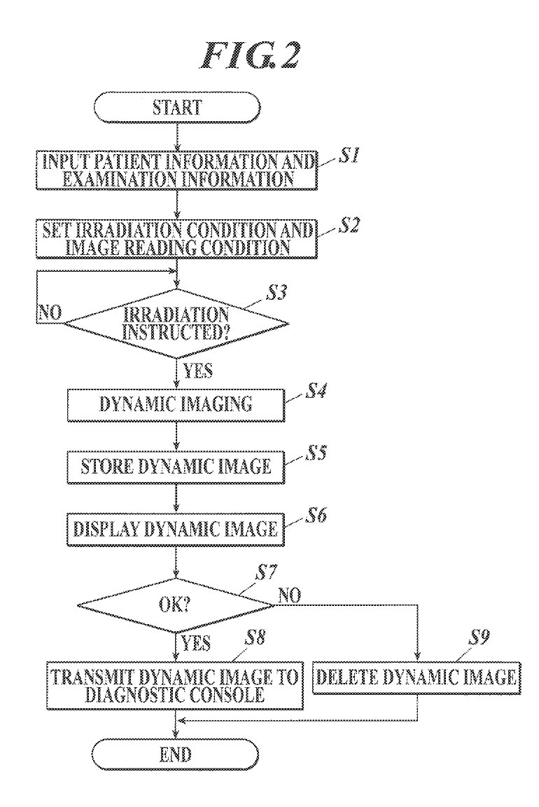

The storage section 22 is configured by including a non-volatile semiconductor memory, a hard disk or the like. The storage section 22 stores various programs executed by the control section 21, parameters necessary for executing processing by the programs, and data of processing results. For example, the storage section 22 stores a program for executing the imaging control processing shown in FIG. 2. The storage section 22 stores the irradiation condition and the image reading condition so as to be associated with the imaging site. The various programs are stored in a form of readable program code, and the control section 21 executes the operations according to the program code as needed.

The operation section 23 is configured by including a keyboard including cursor keys, numeric keys and various function keys and a pointing device such as a mouse. The operation section 23 outputs an instruction signal input by a key operation to the keyboard or a mouse operation to the control section 21. The operation section 23 may include a touch panel on the display screen of the display section 24. In this case, the operation section 23 outputs the instruction signal which is input via the touch panel to the control section 21.

The display section 24 is configured by a monitor such as an LCD (Liquid Crystal Display) and a CRT (Cathode Ray Tube), and displays instructions input from the operation section 23, data and such like in accordance with an instruction of a display signal input from the control section 21.

The communication section 25 includes a LAN adapter, a modem, a TA (Terminal Adapter) and such like, and controls the data transmission and reception with the apparatuses connected to the communication network NT.

### [Configuration of Diagnostic Console 3]

The diagnostic console 3 is a dynamic image processing apparatus for obtaining the dynamic image from the imaging console 2 and displaying the obtained dynamic image and an analysis result image by analyzing the obtained dynamic image to support diagnosis by a doctor.

As shown in FIG. 1, the diagnostic console 3 is configured by including a control section 31, a storage section 32, an operation section 33, a display section 34 and a communication section 35, which are connected to each other via a bus 36.

The control section 31 is configured by including a CPU, a RAM and such like. According to the operation of the operation section 33, the CPU of the control section 31 reads out system programs stored in the storage section 32 and various processing programs to load them into the RAM and executes the various types of processing including after-mentioned dynamic image display processing in accordance with the loaded program.

The storage section 32 is configured by including a nonvolatile semiconductor memory, a hard disk or the like. The storage section 32 stores various programs including a program for executing the dynamic image display processing by the control section 31, parameters necessary for executing processing by the programs and data of processing results or the like. The various programs are stored in a form of readable program code, and the control section 31 executes the operations according to the program code as needed.

The storage section 32 also stores a dynamic image which was obtained by dynamic imaging in the past so as to be associated with an identification ID for identifying the dynamic image, patient information, examination information, information on an image feature targeted in the diagnosis and such like.

Here, when a doctor performs diagnosis on the basis of the dynamic image or an analysis result image (to be described in detail later) which was generated on the basis of the dynamic image, if there is an image feature such as a longer expiratory time compared to an inspiratory time, a longer respiratory time, less change in density and a bad movement of a diaphragm, for example, the doctor performs diagnosis targeting the image feature. Thus, when the diagnostic console 3 displays the dynamic image or the analysis result image thereof on the display section 34, the diagnostic console 3 also displays a user interface for inputting or specifying information on the image feature targeted by the doctor. The storage section 32 stores the information on the image feature which was input or specified by the operation section 33 from the user interface so as to be associated with the dynamic image.

In the embodiment, in a case where the diagnosis target is ventilation, it is possible to input or specify, as the targeted image feature, any of a ratio (or difference) between an expiratory time and an inspiratory time, a respiratory time, a density change amount, a movement amount of a diaphragm, and an average change amount of a density or the movement amount of the diaphragm in expiration and inspiration. In a case where the diagnosis target is a pulmonary blood flow, it is possible to input or specify, as the targeted image feature, a time of one period, a density change amount, an average change amount from a maximum to a minimum (or from a minimum to a maximum) of the density change in one period, and such like.

As the past dynamic image, there is stored a dynamic image formed of a frame image group for one period of the dynamic state which was used for diagnosis.

The operation section 33 is configured by including a keyboard including cursor keys, numeric keys and various function keys and a pointing device such as a mouse, and outputs an instruction signal input by a key operation to the keyboard and a mouse operation to the control section 31. The operation section 33 may include a touch panel on the display screen of the display section 34. In this case, the operation section 33 outputs an instruction signal, which was input via the touch panel, to the control section 31.

The display section 34 is configured by including a monitor such as an LCD and a CRT, and performs various displays in accordance with the instruction of a display signal input from the control section 31.

The communication section 35 includes a LAN adapter, a modem, a TA and such like, and controls data transmission and reception with the apparatuses connected to the communication network NT.

### [Operation of Dynamic Image Processing System 100]

Next, the operation of the dynamic image processing system 100 will be described.

### (Operations of Imaging Apparatus 1 and Imaging Console 2)

First, imaging operation by the imaging apparatus 1 and the imaging console 2 will be described.

FIG. 2 shows imaging control processing executed by the control section 21 in the imaging console 2. The imaging control processing is executed in cooperation between the control section 21 and the program stored in the storage section 22.

First, the operator operates the operation section 23 in the imaging console 2, and inputs patient information of the patient being tested (patient name, height, weight, age, sex and such like) and examination information (imaging site (here, chest) and the type of the diagnosis target (ventilation, pulmonary blood flow or the like)) (step S1).

Next, the irradiation condition is read out from the storage section 22 and set in the irradiation control apparatus 12, and the image reading condition is read out from the storage section 22 and set in the reading control apparatus 14 (step S2).

An instruction of irradiation by the operation of the operation section 23 is waited (step S3). The operator locates the subject M between the radiation source 11 and the radiation detection section 13, and performs positioning. The operator instructs the patient being tested to be at ease to lead into quiet breathing. The operator may induce deep breathing by instructing “breathe in, breathe out”, for example. In a case where the diagnosis target is pulmonary blood flow, for example, the operator may instruct the patient being tested to bold the breath since the image feature is obtained more easily when the imaging is performed while the patient holds the breath. When the preparation for imaging is completed, the operator operates the operation section 23 to input an irradiation instruction.

It is preferable that the irradiation condition, image reading condition, imaging distance and imaging state of the subject M (for example, posture, breathing state and such like) when imaging is performed are set similarly to those of the past dynamic imaging.

When the irradiation instruction is input from the operation section 23 (step S3: YES), the imaging start instruction is output to the irradiation control apparatus 12 and the reading control apparatus 14, and the dynamic imaging is started (step S4). That is, radiation is emitted by the radiation source 11 at the pulse interval set in the irradiation control apparatus 12, and frame images are obtained by the radiation detection section 13.

When the imaging is finished for a predetermined number of frames, the control section 21 outputs an instruction to end the imaging to the irradiation control apparatus 12 and the reading control apparatus 14, and the imaging operation is stopped. The imaging is performed to obtain the number of frame images which can capture m respiration cycles (m>1, m is integer).

The frame images obtained by the imaging are input to the imaging console 2 in order, stored in the storage section 22 so as to be associated with respective numbers (frame numbers) indicating the imaging order (step S5), and displayed on the display section 24 (step S6). The operator confirms positioning and such like by the displayed dynamic image, and determines whether an image appropriate for diagnosis was acquired by the imaging (imaging was successful) or imaging needs to be performed again (imaging failed). The operator operates the operation section 23 and inputs the determination result.

If the determination result indicating that the imaging was successful is input by a predetermined operation of the operation section 23 (step S7: YES), each of a series of frame images obtained by the dynamic imaging is accompanied with information such as the identification ID for identifying the dynamic image, the patient information, the examination information, the irradiation condition, the image reading condition and the number (frame number) indicating the imaging order (for example, the information is written into a header region of the image data in the DICOM format), and transmitted to the diagnostic console 3 via the communication section 25 (step S8). Then, the processing ends. On the other hand, if the determination result indicating that the imaging failed is input by a predetermined operation of the operation section 23 (step S7: NO), the series of frame images stored in the storage section 22 is deleted (step S9), and the processing ends. In this case, the imaging needs to be performed again.

### (Operation of Diagnostic Console 3)

Next, the operation of the diagnostic console 3 will be described.

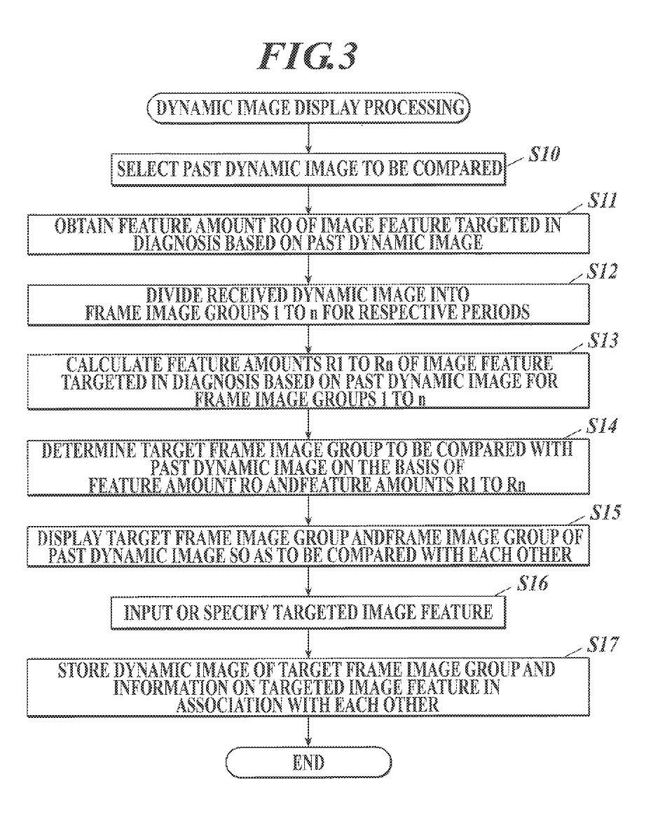

In the diagnostic console 3, when the series of frame images forming the dynamic image is received from the imaging console 2 via the communication section 35, the dynamic image display processing shown in FIG. 3 is executed in cooperation between the control section 31 and the program stored in the storage section 32.

Hereinafter, the flow of the dynamic image display processing will be described with reference to FIG. 3.

First, the past dynamic image (first dynamic image) which is to be displayed and compared with the received dynamic image (second dynamic image) is selected (step S10).

In step S10, the dynamic image which was most recently captured may be automatically selected by the control section 31 from among the past dynamic images capturing the subject M and stored in the storage section 32. A list of the past dynamic images capturing the subject M and stored in the storage section 32 may be displayed on the display section 34 and the user may select a dynamic image from the list by the operation section 33.

Then, a feature amount R0 of the image feature targeted in the diagnosis based on the selected dynamic image is obtained (step S11).

In step S11, information on the image feature targeted in the diagnosis based on the selected past dynamic image is read out from the storage section 32, and the feature amount R0 of the targeted image feature is calculated. As the information on the image feature, not only the information indicating the item of the image feature, the feature amount RD itself of the image feature may be calculated and stored in the storage section 32. In this case, in step S11, the feature amount R0 of the image feature may be read out and obtained from the storage section 32.

The received dynamic image is divided into frame image groups for respective periods of the dynamic state (step S112).

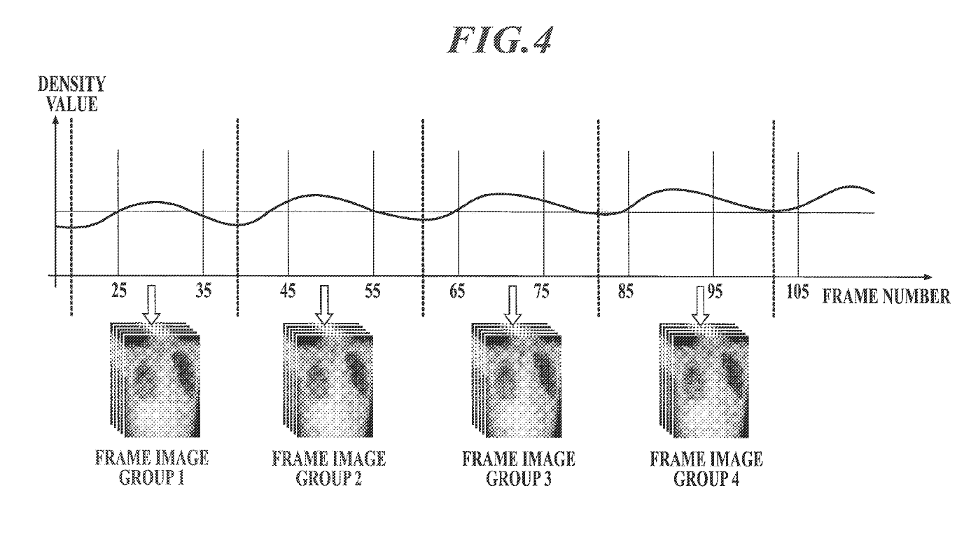

In the division in step S12, for example, density change of the entire image is used. For example, a representative value (for example, average value, median value or the like) of the density values is calculated in each frame image of the dynamic image, and as shown in FIG. 4, a waveform of the density change is obtained by plotting the calculated representative values of the density values temporally (in the frame image order). The waveform is divided at frame images corresponding to local values (local maximum or local minimum), and thereby the dynamic image is divided into frame image groups for respective periods of the dynamic state of the subject M. The dynamic image may be divided into frame image groups for respective periods of the dynamic state by extracting the target site (for example, lung field region) from the dynamic image and using the density change in the extracted region.

For example, in a case where the diagnosis target is ventilation, the division may be performed after the density change is subjected to low pass filter processing (for example, cutoff frequency is 0.85 Hz) in the time direction. Thus, it is possible to remove the signal change of high frequency caused by pulmonary blood flow and such like and accurately extract the density change caused by the ventilation.

For example, in a case where the diagnosis target is pulmonary blood flow, the division may be performed after the density change is subjected to high pass filter processing (for example, cutoff frequency is 0.85 Hz) in the time direction. Thus, it is possible to remove the signal change of low frequency caused by ventilation and such like and accurately extract the density change caused by the pulmonary blood flow. The density change by the pulmonary blood flow may be extracted by using a band pass filter (for example, cutoff frequency of low range is 0.8 Hz and cutoff frequency of high range is 2.4 Hz).

In a case where the diagnosis target is ventilation, the division into a plurality of frame image groups may be performed by using the change in the movement amount of the diaphragm. For example, in each frame image of the dynamic image, the diaphragm is recognized, the y coordinate at a position of an x coordinate on the recognized diaphragm is obtained, and the distance between the obtained y coordinate and a y coordinate which is a reference (for example, distance from the y coordinate at the resting expiration position or the distance between the obtained y coordinate and the lung apex) is plotted temporally. Thereby, a waveform of the temporal change in the movement amount of the diaphragm is obtained and divided at frame images corresponding to the local values (local maximum or local minimum) to divide the dynamic image into frame image groups (frame image groups 1 to n (n>1 and n is integer)) for respective periods of the dynamic state of the subject. Here, the horizontal direction is referred to as x direction and the vertical direction is referred to as y direction in each of the frame images.

As for recognition of the diaphragm, for example, a lung field region is recognized from the frame image, and the outline of the lower section of the recognized lung field region can be recognized as the diaphragm. The lung field region may be extracted by any method. For example, a threshold value is obtained by a discriminant analysis from histogram of the signal value for each pixel of the frame image to recognize the lung field region, and the region having higher signals than the threshold value is primarily extracted as a lung field region candidate. Then, edge detection is performed around the border of the lung field region candidate which was primarily extracted, and the points having largest edges in sub-regions around the border are extracted along the border to extract the border of the lung field region.

Next, feature amounts R1 to Rn of the image feature which was targeted in the diagnosis based on the past dynamic image are calculated for the respective frame image groups I to n (step S13).

As described above, in a case where the diagnosis target is ventilation, the image feature is any of a ratio (or a difference) between the expiratory time and the inspiratory time, a respiratory time, a density change amount, a movement amount of the diaphragm, and an average change amount of a density or the movement amount of the diaphragm in expiration and inspiration. In a case where the diagnosis target is pulmonary blood flow, the image feature is any of a time of one period, a density change amount and an average change amount from a maximum to a minimum (or from a minimum to a maximum) of the density change in one period.

The feature amounts R1 to Rn of the image feature can be calculated on the basis of the density change or the movement amount of the diaphragm in the frame image groups.

As for the ratio between the expiratory time and the inspiratory time, the expiratory time is obtained by calculating the time required for the density or the movement amount of the diaphragm to change from the local maximum to the local minimum in the frame image group, the inspiratory time is obtained by calculating the time required for the density or the movement amount of the diaphragm to change from the local minimum to the local maximum in the frame image group, and the value of the ratio between the expiratory time and the inspiratory time can be calculated. The respiratory time can be calculated by adding the expiratory time to the inspiratory time.

The density change amount can be obtained by calculating the amplitude value of the density change in the frame image group.

The movement amount of the diaphragm can be obtained by calculating the amplitude value of the movement amount of the diaphragm in the frame image group.

The time of one period of the pulmonary blood flow can be obtained by calculating the time required for the density in the frame image group to change from the local maximum (local minimum) to the next local maximum (local minimum).

In a case where the diagnosis target is ventilation, it is preferable that the feature amounts R1 to Rn are calculated after performing the low pass filter processing (for example, cutoff frequency is 0.85 Hz) in the time direction to the density change of each of the frame image groups. Thereby, it is possible to remove the signal change of high frequency by the pulmonary blood flow and such like and accurately extract the density change by the ventilation.

In a case where the diagnosis target is pulmonary blood flow, it is preferable that the feature amounts R1 to Rn are calculated after performing the high pass filter processing (for example, cutoff frequency is 0.85 Hz) in the time direction to the density change of each of the frame image groups. Thereby, it is possible to remove the signal change of low frequency by the ventilation and such like and accurately extract the density change by the pulmonary blood flow. The density change by the pulmonary blood flow may be extracted by using a bandpass filter (for example, cutoff frequency of low range is 0.8 Hz and cutoff frequency of high range is 2.4 Hz).

The feature amounts R1 to Rn regarding the ventilation and the pulmonary blood flow can be calculated more accurately by extracting the lung field region from each of the frame images and calculating the density change by using pixels in the region.

Next, a target frame image group to be compared with the past dynamic image is determined on the basis of the feature amounts R0 and R1 to Rn (step S14).

In step S14, for example, the frame image group to be compared with the past dynamic image can be determined by any method of the following (1) and (2), for example.

(1) The frame image group corresponding to the feature amount, among the feature amounts R1 to Rn, which has the value closest to the value of the feature amount R0 which was calculated from the past dynamic image is determined as the target frame image group to be compared with the past dynamic image.
(2) The frame image group corresponding to the feature amount, among the feature amounts R1 to Rn, which has the value furthest from the value of the feature amount R0 which was calculated from the past dynamic image is determined as the target frame image group to be compared with the past dynamic image.

Which of the above (1) and (2) methods is used to determine the target frame image group can be set by the operation section 33 in advance. By using the method of (1), it is possible to compare the state which is close to the past. By using the method (2), it is possible to compare the state which is largely different from the past.

Next, the determined target frame image group and the frame image group of the past dynamic image are displayed alongside so as to be compared with each other on the display section 34 (step S15).

In step S15, it is preferable that moving images of the target frame image group and the frame image group of the past dynamic image are reproduced alongside each other. At this time, since each of the two frame image groups possibly has a different time of one period of the dynamic state, it is preferable to reproduce the moving images by aligning the time of one period.

For example, in a case where the target frame image group is determined by the above (1) method, when the target frame image group is nearly same as the past dynamic image, it is found that the medical condition is not changed. When the target frame image group is different from the past dynamic image, it is found that the medical condition has changed (become better or worse). When the target frame image group is largely different from the past dynamic image, problems in photography may be doubted.

For example, in a case where the target frame image group is determined by the above (2) method, when the target frame image group is nearly same as the past frame image group, it is found that the medical condition is not changed and the respiration (pulmonary blood flow) for a plurality of periods is stable.

Then, the image feature targeted by the doctor is input or specified (step S16).

For example, an “image feature” button for inputting or specifying the image feature targeted by a doctor watching the dynamic image is provided on the screen displayed in step S15. When the “image feature” button is pressed by the operation section 33, an input screen for inputting or specifying the image feature targeted by the doctor pops up on the display section 34 and receives the input or specification of the image feature by the doctor.

Here, it is preferable that the feature amount of the input or specified image feature is calculated for the target frame image group and the calculated feature amount is displayed with the image on the display section 34. In a case where the input or specified image feature is the image feature amount used for determination of the target frame image group, the feature amount which was calculated for the target frame image group in step S13 may be displayed with the image on the display section 34.

When end of the diagnosis is instructed by the operation section 33, information on the input or specified image feature and the dynamic image formed of the target frame image group are stored in the storage section 32 so as to be associated with each other (step S17), and the dynamic image display processing ends.

Here, in addition to the information on the image feature, the identification ID for identifying the dynamic image, the patient information, the examination information and such like are stored so as to be associated with the dynamic image formed of the target frame image group. The feature amount of the input or specified image feature may be calculated for the target frame image group and the calculated feature amount may be stored as the information on the image feature in the storage section 32 so as to be associated with the dynamic image. In a case where the input or specified image feature is the image feature amount used for determination of the target frame image group, the feature amount which was calculated for the target frame image group in step S13 may be stored in the storage section 32 so as to be associated with the dynamic image.

In this way, in the dynamic image display processing, it is possible to automatically determine the frame image group appropriate to be compared with the dynamic image which was photographed in the past. As a result, it is possible to perform appropriate diagnosis promptly.

### Second Embodiment

Hereinafter, a second embodiment of the present invention will be described.

The first embodiment has been described by taking, as an example, a case of displaying and comparing the photographed dynamic images themselves. However, the second embodiment will be described by taking, as an example, a case of displaying and comparing analysis result images which are obtained by performing analysis processing to the dynamic images.

Since the configurations and the operations of the imaging apparatus 1 and the imaging console 2 in the second embodiment are similar to those explained in the first embodiment, the explanation thereof is omitted. The operation of the diagnostic console 3 will be described.

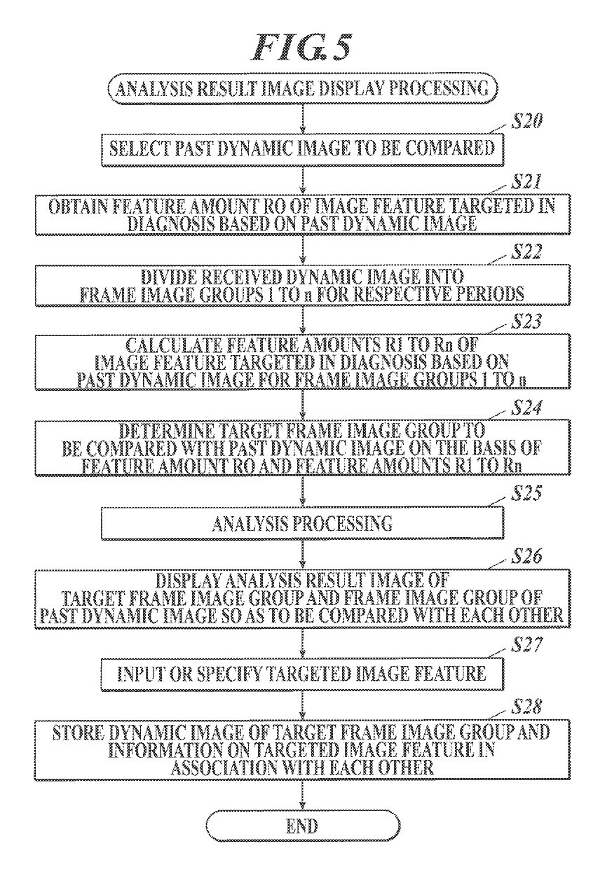

In the diagnostic console 3, when a series of frame images of the dynamic image is received from the imaging console 2 via the communication section 35, analysis result image display processing shown in FIG. 5 is executed in cooperation between the control section 31 and a program stored in the storage section 32.

Hereinafter, the flow of the analysis result image display processing will be described with reference to FIG. 5.

First, by executing the processing of steps S20 to S24, the target frame image group to be used for comparison with the past dynamic image is determined in the received dynamic image. Since the processing of steps S20 to S24 are similar to that of steps S10 to S14 in FIG. 3 which was explained in the first embodiment, the explanation thereof is omitted. The image feature targeted in diagnosis based on the past dynamic image includes the image feature targeted in diagnosis by the analysis result image calculated on the basis of the past dynamic image.

Next, analysis processing is performed to each of the target frame image group and the frame image group of the past dynamic image (step S25).

The analysis processing is, for example, frequency filter processing in the time direction. For example, in a case where the diagnosis target is ventilation, the low pass filter processing (for example, cutoff frequency is 0.85 Hz) in the time direction is performed to the density change of the frame image group, and the analysis result image extracting the density change by the ventilation is generated. For example, in a case where the diagnosis target is pulmonary blood flow, the high pass filter processing (for example, cutoff frequency is 0.85 Hz) in the time direction is performed to the frame image group, and the analysis result image extracting the density change by the pulmonary blood flow is generated. The density change by the pulmonary blood flow may be extracted by filter processing using a bandpass filter (for example, cutoff frequency of low range is 0.8 Hz and cutoff frequency of high range is 2.4 Hz) to the density change of the frame image group.

As the analysis processing, frequency filter processing in the time direction may be performed for each pixel unit by associating pixels at a same position in the respective frame images of the frame image group, or the frequency filter processing in the time direction may be performed for each sub-region unit by dividing each of the frame images of the frame image group into sub-regions formed of a plurality of pixels, calculating a representative value (for example, average value, median value or the like) of density values of the respective divided sub-regions and associating the divided sub-regions between the frame images (for example, associating sub-regions at a same pixel position).

There may be obtained a representative value (for example, variance value) in the time direction for each pixel (or each sub-region) of the frame image group which was subjected to the analysis processing, and a single image having the pixel values of the obtained values may be generated as the analysis result image.

Next, the analysis result image of the target frame image group and the analysis result image of the past dynamic image are displayed alongside so as to be compared with each other on the display section 34 (step S26).

In step S26, in a case where the analysis result image is formed of a frame image group, it is preferable that moving images of the analysis result images are reproduced. At this time, since each of the analysis result images possibly has a different time of one period of the dynamic state and a different frame rate, it is preferable that the moving images are reproduced with an aligned time of one period of the dynamic state and an aligned frame rate in both the images.

For example, in a case where the target frame image group is determined by the above (1) method, when the analysis result image of the target frame image group is nearly same as the analysis result image of the past dynamic image, it is found that the medical condition is not changed. When the analysis result image of the target frame image group is different from the analysis result image of the past dynamic image, it is found that the medical condition has changed (become better or worse). When the analysis result image of the target frame image group is largely different from the analysis result image of the past dynamic image, problems in photography may be doubted.

For example, in a case where the target frame image group is determined by the above (2) method, when the analysis result image of the target frame image group is nearly same as the analysis result image of the past dynamic image, it is found that the medical condition is not changed and the dynamic state (respiration or pulmonary blood flow) for a plurality of periods is stable.

Then, the image feature targeted by the doctor is input or specified (step S27).

For example, an “image feature” button for inputting or specifying the image feature which was targeted by the doctor watching the dynamic image is provided on the screen displayed in step S27. When the “image feature” button is pressed by the operation section 33, an input screen for inputting or specifying the image feature targeted by the doctor pops up on the display section 34 and receives the input or specification of the image feature by the doctor.

Here, it is preferable that the feature amount of the input or specified image feature is calculated for the target frame image group and the calculated feature amount is displayed with the image on the display section 34. In a case where the input or specified image feature is the image feature amount used for determination of the target frame image group, the feature amount which was calculated for the target frame image group in step S23 may be displayed with the image on the display section 34.

When end of the diagnosis is instructed by the operation section 33, information on the input or specified image feature and the dynamic image formed of the target frame image group are stored in the storage section 32 so as to be associated with each other (step S28), and the dynamic image display processing ends.

Here, in addition to the information on the image feature, the identification ID for identifying the dynamic image, the patient information, the examination information and such like are stored so as to be associated with the dynamic image formed of the target frame image group. The feature amount of the input or specified image feature may be calculated for the target frame image group and the calculated feature amount may be stored as the information on the image feature in the storage section 32 so as to be associated with the dynamic image. In a case where the input or specified image feature is the image feature amount used for determination of the frame image group, the feature amount which was calculated for the target frame image group in step S23 may be stored in the storage section 32 so as to be associated with the dynamic image.

In this way, in the analysis result image display processing, it is possible to automatically determine, from the photographed dynamic image, the frame image group which is appropriate to be compared with the dynamic image which was photographed in the past. The analysis result image of the determined frame image group and the analysis result image of the dynamic image which was photographed in the past are automatically generated and displayed alongside. Thus, it is possible to perform appropriate diagnosis promptly.

Though the above analysis result image display processing has been described by taking, as an example, a case where the analysis processing is the frequency filter processing in the time direction, the analysis processing is not limited to this. For example, the analysis processing may be inter-frame difference processing of calculating the difference value of density values of corresponding (for example, having a same pixel position) pixels or sub-regions between a plurality of frame images (for example, between adjacent frame images) in the targeted frame image group of the dynamic image (and frame image group of the past dynamic image). It is preferable that the above frequency filter processing in the time direction is performed before performing the inter-frame difference processing. It is also preferable that each pixel (or each sub-region) of the inter-frame difference image is displayed with a color corresponding to the difference value.

In a case where the diagnosis target is the pulmonary blood flow, as described in Japanese Patent Application Laid Open Publication No. 2012-5729, there may be generated, as the analysis result image, an image obtained by calculating the blood flow signal waveform (density change waveform) by the pixel unit or the blood flow signal waveform by the sub-region unit in the target frame image group of the dynamic image (and of the past dynamic image), calculating the cross-correlation coefficient between the pulsating waveform and the blood flow waveform while shifting the blood flow waveform by one frame interval (while shifting in the time direction) with respect to the pulsating waveform, and adding, to each pixel or each sub-region, the color corresponding to the maximum cross-correlation coefficient among the plurality of cross-correlation coefficients calculated by the shifting for a total of one or more heart beat periods.

The blood flow waveform can be obtained by performing the high pass filter processing (for example, cutoff frequency is 0.8 Hz) in the time direction to the signal value change (that is, density change) of pixel unit (or sub-region unit) of the frame image group.

As the pulsating waveform, any of the followings can be used.

(a) waveform indicating the temporal change in the signal value of an ROI (region of interest) which is determined in a heart region (or aorta region)

(b) signal waveform inverting the waveform of (a)

(c) electrocardiogram signal waveform obtained by an electrocardiogram detection sensor

(d) signal waveform indicating the movement (change in position) of the heart wall

The cross-correlation coefficient can be obtained by the following [Numerical Expression 1].

$$C = \frac{1}{J} {\sum }_{j = 1}^{J} \frac{\{ A ( j ) - {m}_{A} \} \{ B ( j ) - {m}_{B} \}}{{σ}_{A} {σ}_{B}} \\ {m}_{A} = \frac{1}{J} {\sum }_{j = 1}^{J} A ( j ) , {m}_{B} = \frac{1}{J} {\sum }_{j = 1}^{J} B ( j ) \\ {σ}_{A} = \sqrt{\frac{1}{J} {\sum }_{j = 1}^{J} {\{ A ( j ) - {m}_{A} \}}^{2}} \\ {σ}_{B} = \sqrt{\frac{1}{J} {\sum }_{j = 1}^{J} {\{ B ( j ) - {m}_{B} \}}^{2}} \qquad [ Numerical Expression 1 ]$$

C: cross-correlation coefficient

A(j): j-th signal value in all the J signals included in the pulsating waveform

m_{A}: average signal value of all the signals included in the pulsating waveform

σ_{A}: standard deviation of all the signals included in the pulsating waveform

B(j): j-th signal value in all the J signals included in the output signal waveform of the sub-region

m_{B}: average signal value of all the signals included in the output signal waveform of the sub-region

σ_{B}: standard deviation of all the signals included in the output signal waveform of the sub-region

A representative value (for example, maximum value, minimum value, average value or variance value) in the time direction may be obtained for each pixel of the frame image group which was subjected to the analysis processing, and a single image having the obtained values as the pixel values may be generated as the analysis result image.

In the above analysis result image display processing, the analysis processing is performed to the dynamic image of the determined target frame image group in the received dynamic image. However, the analysis processing may be performed to the entire received dynamic image so that, when display is performed in step S26, the analysis result image of the determined target frame image group is selected and displayed alongside the past dynamic image.

In the above analysis result image display processing, only the analysis result images of the target frame image group and the past dynamic image are displayed so as to be compared with each other. However, the target frame image group and the past dynamic image may also be displayed and compared together.

As described above, according to the diagnostic console 3, a past dynamic image which was obtained by photographing a dynamic state of a subject having periodicity and information on an image feature targeted in diagnosis based on the past dynamic image are stored in the storage section 32 so as to be associated with each other. On the basis of the information on the image feature which is stored so as to be associated with the past dynamic image, the control section 31 determines a frame image group which is to be displayed and compared with the past dynamic image from among frame image groups for respective periods in the dynamic image which was obtained by photographing the dynamic state of the same subject for a plurality of periods. For example, the control section 31 divides the plurality of frame images of the photographed dynamic image into a plurality of frame image groups for the respective periods of the dynamic state, calculates the feature amount of the image feature for each of the plurality of divided frame image groups, and determines the frame image group to be displayed and compared with the first dynamic image from among the plurality of frame image groups on the basis of the comparison between the calculated feature amount and the feature amount of the image feature which was calculated for the past dynamic image.

Accordingly, it is possible to automatically determine, in the photographed dynamic image, the frame image group which is appropriate to be compared with the past dynamic image. As a result, appropriate diagnosis can be performed promptly.

For example, the control section 31 determines, as the frame image group to be displayed and compared with the past dynamic image, the frame image group for which the calculated feature amount of the image feature is closest to the feature amount which was calculated for the past dynamic image from among the plurality of frame image groups of the photographed dynamic image. Accordingly, it is possible to determine, as the frame image group to be displayed and compared, the frame image group which enables the user to appropriately grasp whether the medical condition has changed from the past diagnosis by the display and comparison with the past dynamic image.

For example, the control section 31 determines, as the frame image group to be displayed and compared with the past dynamic image, the frame image group for which the calculated feature amount of the image feature is furthest from the feature amount which was calculated for the past dynamic image from among the plurality of frame image groups of the photographed dynamic image. Accordingly, it is possible to determine, as the frame image group to be displayed and compared, the frame image group which enables the user to appropriately grasp a stable case having no change in medical condition from the diagnosis which was performed based on the past dynamic image and such like by the display and comparison with the past dynamic image.

The description in the embodiment is an example of a preferred dynamic image processing system according to the present invention, and the present invention is not limited to the above description.

For example, the embodiment has been described by taking, as an example, a case where the present invention is applied to the dynamic image of the chest. However, the present invention is not limited to this. The present invention may be applied to dynamic images obtained by photographing other sites.

The embodiment has been described that a target frame image group (that is, frame image group for the period which was used in diagnosis) among a series of the photographed frame images is stored as the dynamic image in the storage section 32. However, the series of the photographed frame images may be stored as the dynamic image in the storage section 32. In this case, the dynamic image may be stored so as to be associated with information on the period which was used in the diagnosis so that, in the above dynamic image display processing and the analysis result image display processing, the frame image group of the period used in the diagnosis is specified in the past dynamic image stored in the storage section 32, and used as the past dynamic image.

The embodiment has been described by taking, as an example, a case where a storage, a hardware processor and a display according to the present invention are provided inside the diagnostic console 3 which is a single apparatus. However, one or more of the storage, hardware processor and display may be externally provided via a communication network.

The embodiment has been described for an example of using a hard disk, a semiconductor non-volatile memory or the like as a computer readable medium of the program according to the present invention. However, the present invention is not limited to this example. A portable recording medium such as a CD-ROM can be applied as a computer readable medium. A carrier wave is also applied as the medium for providing program data according to the present invention via a communication line.

The other detailed configurations and detailed operations of the apparatuses forming the dynamic image processing system 100 can also be appropriately changed within the scope of the present invention.

Although embodiments of the present invention have been described and illustrated in detail, it is clearly understood that the same is by way of illustration and example only and not limitation, the scope of the present invention should be interpreted by terms of the appended claims.

Japanese Patent Application No. 2016-222052 filed on Nov. 15, 2016, including description, claims, drawings, and abstract the entire disclosure is incorporated herein by reference in its entirety.

What is claimed is:

1. A dynamic image processing system, comprising:
a storage in which a first dynamic image and information on an image feature that is input or specified by a user and based on the first dynamic image are stored so as to be associated with each other, the first dynamic image being obtained by photographing a dynamic state of a subject which has periodicity; and
a hardware processor which determines a frame image group that is to be displayed and compared with the first dynamic image from among frame image groups for a plurality of respective periods in a second dynamic image based on the information on the image feature that is stored so as to be associated with the first dynamic image, the second dynamic image being obtained by photographing the dynamic state for the periods after photographing of the first dynamic image.

2. The dynamic image processing system according to claim 1, wherein the hardware processor divides a plurality of frame images of the second dynamic image into a plurality of frame image groups for the respective periods of the dynamic state, calculates a feature amount of the image feature in each of the divided frame image groups and determines the frame image group that is to be displayed and compared with the first dynamic image from among the plurality of frame image groups based on comparison between the calculated feature amount and a feature amount of the image feature that is calculated for the first dynamic image.

3. The dynamic image processing system according to claim 2, wherein the hardware processor determines, as the frame image group that is to be displayed and compared with the first dynamic image, a frame image group for which the calculated feature amount of the image feature is closest to the feature amount of the image feature that is calculated for the first dynamic image from among the plurality of frame image groups.

4. The dynamic image processing system according to claim 2, wherein the hardware processor determines, as the frame image group that is to be displayed and compared with the first dynamic image, a frame image group for which the calculated feature amount of the image feature is furthest from the feature amount of the image feature that is calculated for the first dynamic image from among the plurality of frame image groups.

5. The dynamic image processing system according to claim 1, further comprising a display which displays a frame image group in the first dynamic image and the determined frame image group in the second dynamic image alongside each other.

6. The dynamic image processing system according to claim 1, wherein the hardware processor performs analysis processing to each of a frame image group in the first dynamic image and the determined frame image group in the second dynamic image.

7. The dynamic image processing system according to claim 6, further comprising a display which displays an analysis result image of the frame image group in the first dynamic image and an analysis result image of the determined frame image group in the second dynamic image alongside each other.

8. The dynamic image processing system according to claim 1, wherein the image feature is any of a time of one period of the subject, a density change amount and an average change amount from a maximum to a minimum or from a minimum to a maximum of a density in the one period of the subject.

9. The dynamic image processing system according to claim 1, wherein, when the first dynamic image is a dynamic image of a chest, the image feature is any of a ratio or a difference between an expiratory time and an inspiratory time, a respiratory time, a density change amount, a movement amount of a diaphragm and an average change amount of a density or the movement amount of the diaphragm in expiration and inspiration.
